(19) United States
(12) Patent Application Publication
(10) Pub. No.: US 2011/0203233 A1
(43) Pub. Date: Aug. 25, 2011

(54) Saddle Pad Pillow

(75) Inventor: Kimberly A. Wasson, Los Gatos, CA (US)

(73) Assignee: Kimberly Ann Wasson, Los Gatos, CA (US)

(21) Appl. No.: 13/004,358

(22) Filed: Jan. 11, 2011

Related U.S. Application Data
(60) Provisional application No. 61/291,972, filed on Feb. 19, 2010.

(51) Int. Cl. B68C 1/12

(52) U.S. Cl. 54/66

(57) ABSTRACT

All English and Western horse saddles require the use of a saddle pad (sometimes called a saddle blanket). This pad sits underneath the saddle to protect the horse from rubbing. Saddle pads are relatively inexpensive and often viewed as fashion accessories so are discarded with regularity. Saddle pad pillows repurpose saddle pads by doubling and sewing the pad, filling with polyfil or kapok, and adding patching or embroidery. The result is a large decorative pillow with a history. Saddle pad pillows provide reuse/repurpose of an item with no other utility and sometimes provide an event or horse keepsake. The pillows will typically be released with information on the previous owner (the horse) so that they can be used as keepsakes.

### BACKGROUND

The new product is a household/decorative item; the general field of endeavor is recycle/reuse.

Horse saddles require use of a saddle pad under the saddle. Saddle pads come in many sizes, colors, and patterns. Not only do the pads wear thin, they are often seen as fashion accessories and most riders have multiple saddle pads that they replace on a regular basis. Currently the main uses for these discarded saddle pads are rags and dog blankets; most are simply thrown away.

This new use (or reuse) solves the problem of how to dispose of used saddle pads as well as finding a new/alternative use for the item. The pads are rarely in a condition so degraded that they cannot be reused in the manner described below. Searches found no patent information related to the problem or product at all, nor do there appear to be any similar products (or any reused saddle pad products at all) on the market as researched by web searches, horse supply/decoration catalogs, etc.

For some uses (such as nursing pillows) new saddle pads might be used for transformation rather than repurposed used saddle pads. The starting point, however, will always be an existing saddle pad.

### SUMMARY

The Saddle Pad Pillow reuses a manufactured saddle pad (also called a saddle blanket), transforming it into a decorative pillow.

### DETAILED DESCRIPTION

Saddle pads are made of many different fabrics but primarily of cotton, cotton/poly blend, poly fleece, or wool. English saddle pads are smaller than Western saddle pads (as English saddles are smaller than Western saddle pads) and typically slightly contoured (show pads are only marginally larger than the saddle and are the same contour); Western pads are larger, heavier, and rectangular with square corners. Embroidered saddle pads are often given as a prize in riding competitions; everyday pads come in a variety of colors and patterns.

Materials

The materials list for the pillow is minimal. The major components are the saddle pad and fill.

Saddle Pad/Saddle Blanket

Saddle pads or blankets (the terms are often used interchangeably, although the term ‘pad’ is more often used for items used with English tack and ‘blanket’ for items used with Western tack) serve as a cushion between the saddle and the horse's back. The pads come in one basic shape but can be contoured. They are made of a number of materials, most commonly quilted cotton, synthetic fleece, and wool. In general the pads are discarded after a year or two of use as they get worn and/or the owner desires a change.

Fill

Fill will be primarily either Polyfill or kapok. Additional fill materials include down, wool, and horsehair.

Thread

Heavy-duty cotton/poly thread is used. Lighter thread may be used to create a logo/design.

Patches

Used saddle pads often have worn areas. If the wear is extensive the worn areas will be patched with compatible material (generally fleece or waffle weave material from used horse blankets) or with embroidery thread.

Construction

Strap Removal

Many (not all) saddle pads have one or two sets of webbed polyester straps. One set, which holds the girth in place, is parallel to the bottom border on both short sides near the middle of each side. This set remains on the pillow. The other set are webbed polyester straps lined with Velcro to hold the pad to the saddle via the girth leathers and consists of loops near the front and top of the pad. If present, these straps are cut near the stitching and the ends melted with a match to avoid fraying.

Patching

Patches will be designed, cut, and machine-stitched onto the saddle pad as needed to cover holes and large fray spots. No other modifications will be made to the saddle pad other than embroidery—it is used as an entity, not cut up to use as fabric.

Initialing and Embroidery

A company logo and/or large design may be embroidered onto the saddle pad by hand or machine.

Sewing the Border

The saddle pad is stitched inside the border topside, about 1.5 inches from the outside edge forming an envelope. All saddle pads are bound on the outside edge so no additional modifications are required. A four-inch gap is left at one end of the pad in order to stuff the pillow.

Stuffing/Fill

The saddle pad pillow is stuffed by hand using loose material.

Completing the Border

After stuffing, the 4-inch gap is closed by machine stitching over the opening in line with the border stitching (1.5 inches from the edge). In some cases fabric glue may be used to reinforce this last set of stitches.

Use

The pillow is not fireproof to sleeping pillow standards so will be used decoratively or as a nursing pillow. Pillows that are not wool can be machine washed and machine dried.

Distinguishing from Other Inventions

Research has not revealed any pillows or other commercially available reuse of saddle pads at all.

1. I claim my invention is is for repurposing and transformation of an existing English or Western saddle pad into a decorative pillow.
